(19) United States
(12) Patent Application Publication
(10) Pub. No.: US 2021/0029892 A1
(43) Pub. Date: Feb. 4, 2021

(54) PLANT TREATMENT SYSTEM AND METHOD

(71) Applicant: Matthew Machata, Lake Wales, FL (US)

(72) Inventor: Matthew Machata, Lake Wales, FL (US)

(21) Appl. No.: 17/073,347

(22) Filed: Oct. 17, 2020

Related U.S. Application Data
(63) Continuation-in-part of application No. 15/943,670, filed on Apr. 2, 2018.
(60) Provisional application No. 62/479,519, filed on Mar. 31, 2017.

(51) Int. Cl. A01G 7/06; A01G 3/053

(52) U.S. Cl. CPC A01G 7/06; A01G 3/053

(57) ABSTRACT

Described are systems and methods for treating and/or helping prevent microbial infections on plants and trees by applying a treatment solution to cut areas of the plants or trees that have been exposed during a hedging or topping operation, or the like.

### RELATED APPLICATIONS

This application is a continuation-in-part of U.S. application Ser. No. 15/943,670, entitled “Plant Treatment System And Method,” which was filed on Apr. 2, 2018, which claims the benefit of U.S. Provisional Application No. 62/479,519, entitled “Plant Treatment System And Method” and filed on Mar. 31, 2017, both of which are incorporated herein by reference in their entirety.

### TECHNICAL FIELD

Some implementations relate generally to commercial agriculture plant and tree treatment systems, and more particularly, to systems and methods for treating microbial infections on plants and trees in commercial groves (or orchards).

### BACKGROUND

Plant and tree diseases cause serious economic damage worldwide every year. For example, in Florida, citrus greening (possibly caused by candidatus liberibacter asiaticus) is a serious threat to the state's citrus industry.

There may be a desire for systems and methods for treating food crops, plants, and trees to help prevent, reduce, or eliminate microbial infections and/or the effects of such infections, while leaving fruit or plants edible.

Some treatments may be applied to the leaves, but leaf application may suffer from a reduced efficiency. When applied to the woody tissue of a tree, such as a citrus tree, an efficiency increase may be achieved. The treatment may be applied via an injection to reach the woody tissue. However, injecting numerous trees, for example in a citrus grove, may be an expensive and time-consuming process.

Some implementations were conceived in light of the above-mentioned problems, needs, and limitations, among other things.

### BRIEF DESCRIPTION OF THE DRAWINGS

FIG. 1 is a flowchart of an example method of treating plants and/or trees in accordance with some implementations.

FIG. 2 is a diagram of an example system for treating plants and/or trees in accordance with some implementations.

FIG. 3 is a diagram of an example hedger/topper configured with a treatment system in accordance with some implementations.

FIG. 4 is a diagram of an example hedger configured with a treatment system in accordance with some implementations.

FIG. 5 is a diagram of an example hedger configured with a treatment system having an adjustable spray boom in accordance with some implementations.

FIGS. 6-8 are diagrams showing details of an adjustable spray boom connection system in accordance with some implementations.

FIG. 9 is a diagram of a hedging or topping machine having a wiper boom to apply treatment solutions in accordance with some implementations.

FIG. 10 is a diagram of a hedging or topping machine having a spinning brush boom to apply treatment solutions in accordance with some implementations.

FIG. 11 is a diagram of a treatment control system in accordance with some implementations.

### DETAILED DESCRIPTION

In general, some implementations include a method of applying a treatment or preventative solution (e.g., a bactericidal solution, nutritional solution, or combination thereof) to a cut area of a plant or tree immediately (or nearly immediately) following a cutting operation such as hedging or topping. By applying the treatment solution to the cut area of the pant or tree immediately after a cutting operation, the treatment solution may be able to reach the woody tissue of the pant or tree. While treatment solutions are described herein as examples, it will be appreciated that a treatment can also include other forms such as powders, foams, dusts, granular solids, gases, vapors, mists, gels, pastes, etc. The treatment systems and methods described herein can be used with the above treatment forms or any other later developed suitable treatment forms.

Some implementations can include hedger and/or a topper machine having a treatment application system attached to the hedger/topper in order to apply the treatment solution immediately after the hedging or topping operation. Some implementations can include a separate implement for application of the treatment, where the separate implement can follow the hedger/topper.

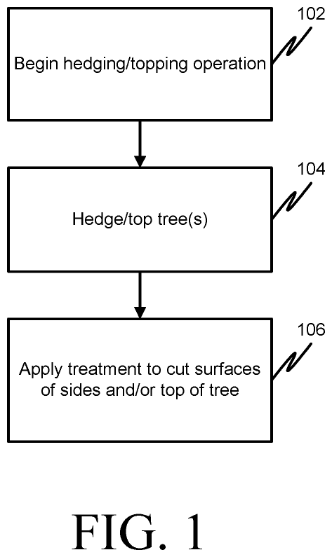

FIG. 1 is a flowchart of an example method of applying a liquid (e.g., a solution for treating and/or helping to prevent microbial infections of plants or trees, a liquid fertilizer, a liquid herbicide, a nutritional, a combination of the above, or in general any liquid treatment where it may be beneficial for the liquid to reach the woody tissue of the plant or tree). The method begins at 102, where a hedging/topping operation is begun. Hedging and topping are operations that are performed periodically (e.g., seasonally, annually, etc.) to trim the sides and/or top of a plant or tree. For example, citrus trees are typically hedged and topped annually. The method continues to 104.

At 104, one or more plants or trees is hedged or topped. The hedging and topping operations may be carried out separately by different machines, one for hedging and one for topping. Alternatively, there may be a combined hedger/topper machine. The method continues to 106.

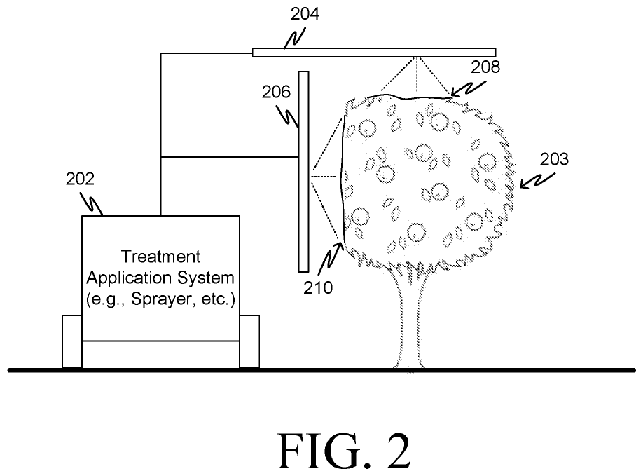

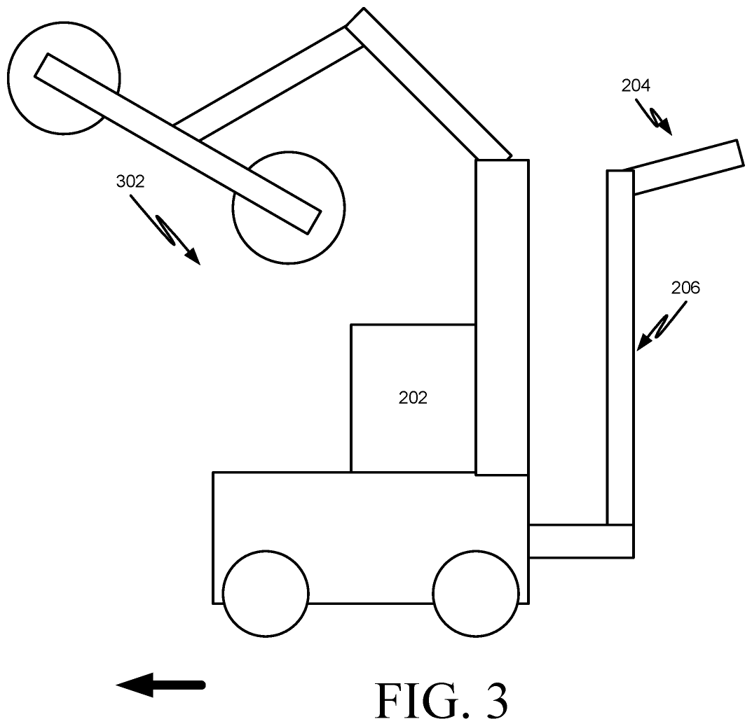

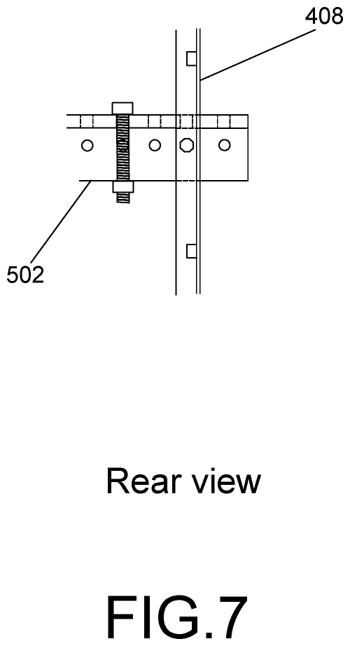

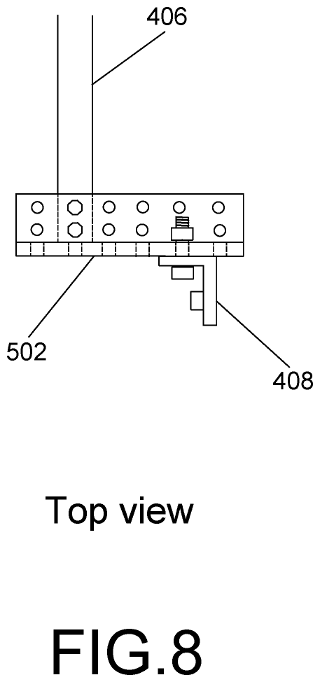

At 106, a treatment (e.g., liquid treatment solution, or the like) is applied to a freshly cut area (e.g., side and/or top) of a plant or tree. Immediately (or nearly immediately) after a hedging or topping operation, woody tissue of a plant or tree is exposed and has moist sap. Immediately (or nearly immediately) after the cutting (hedging or topping) a liquid treatment (e.g., a liquid bactericidal solution, for example: Mycoshield manufactured by Nufarm; and/or FireLine, FireWall, etc. manufactured by AgroSource; or the like) applied to the exposed woody tissue will be absorbed into the woody tissue of the plant or tree. A treatment solution can include a bactericide (such as one of the ones mentioned above), and, optionally, one or more of water, a surfactant, and/or other material such as a nutritional. The treatment solution preferably is applied before the sap of the cut area dries so that the treatment can enter the woody tissue of the tree or plant. By using the above method, a need for injecting treatment solution into woody tissue of a pant or tree may be reduced or eliminated. Further, the efficiency of the treatment can be increased compared to foliar application. The treatment may be applied as shown in FIG. 2 using an apparatus as shown in FIGS. 3-10. For example, the treatment can be applied via a spray boom, a wiper boom, a spinning brush boom, or via other suitable apparatus. It will be appreciated that the above steps may be repeated in whole or in part in order to accomplish a contemplated plant/tree treatment. A controller, as described below, can be used to control the application of the treatment at a controlled rate.

FIG. 2 shows a diagram of a treatment system 202 in accordance with some implementations being used to treat a hedged and topped tree 203. The treatment system 202 can include one or both of a horizontal spray member 204 having one or more horizontal application nozzles to apply a treatment solution to a topped portion 208 of the tree 203, and/or a vertical spray member 206 having one or more vertical spray nozzles to apply a treatment solution to a hedged section 210 of the tree 203. It will be appreciated that a dedicated hedger or topper may have only one of 206 and 204, respectively.

FIG. 3 shows a diagram of an example hedger/topper 302 that includes a treatment system as described herein. The treatment system can include a treatment application device 202, a vertical application member 206 and/or a horizontal application member 204, which operate as described above. The vertical application member 206 can include a spray boom, a wiper boom, a spinning brush boom, or via other suitable apparatus. The horizontal application member 204 can include a spray boom, a wiper boom, a spinning brush boom, or via other suitable apparatus.

It will be appreciated that while examples have been described in terms of system and method configured for both hedging (or vertical trimming) and topping (or horizontal trimming), some implementations could include a machine dedicated for just hedging or just topping. Such dedicated purpose hedging or topping systems would include a corresponding application member (e.g., 206 or 204, respectively). Also, a hedging/topping system may perform one operation at a time. For example, the system may make a first pass to hedge a row of trees and then a second pass to top that row of trees. In such cases, the treatment application system could be configured to have a selectable application delivery to the sides only (for hedging), to the top only (for topping), or to both the sides and the tops (for simultaneous hedging and topping). A dual-purpose hedger/topper may include both 204 and 206.

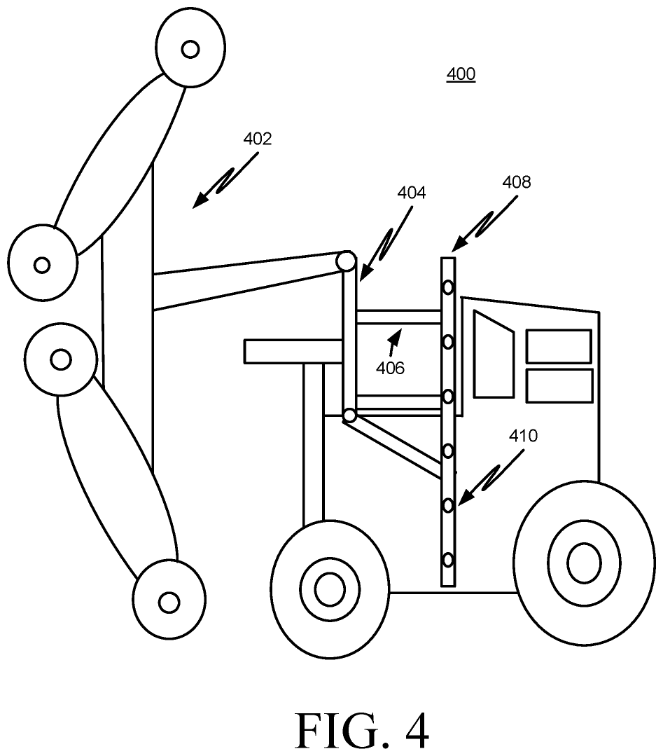

FIG. 4 is a diagram of an example hedger tractor 400 configured with a treatment system in accordance with some implementations. The hedger tractor 400 includes a cutting boom 402, a cutting boom support member 404, one or more attachment boom(s) 406, a spray boom 408, and one or more spray nozzles 410. It will be appreciated that FIG. 4 is showing one side of the hedger 400 and that the other side of the hedger 400 can have a similar configuration (e.g., another set of 402-410).

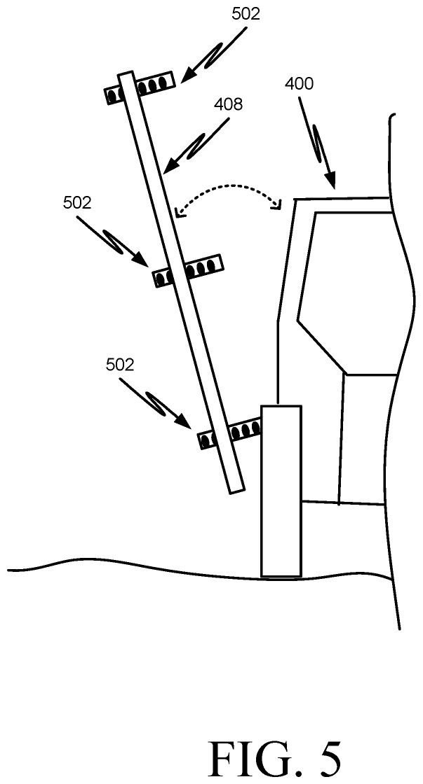

In operation, as the hedger 400 is moving down a rows of trees performing a hedging operation, the spray boom 408 is connected to the cutting boom 402 and can be configured to have an angle that adjusts with the angle of the cutting boom 402 (as shown in FIG. 5). Spray supplied by liquid supply system, e.g., a tank, a pump and connecting liquid transfer lines, to the spray boom 408 and exiting out the spray nozzles 410 is applied to parts of the trees that have just been cut by blades on the cutting boom. The application of spray from the liquid supply system can include a control panel mounted inside an operator control cabin of the hedger 400 coupled to a controller. The control panel can include controls to control the rate of flow of the liquid (or other treatment) to the spray nozzles (or other applicator), pressure of the liquid to the spray nozzles, etc. to provide a controlled rate of delivery or application of the treatment. The control panel can also include controls to set a controlled application rate of a given amount of treatment per unit of land (e.g., 1.5 pounds of treatment per acre of citrus grove), or other suitable rate measure. The control panel can also include controls to cause the system to adjust the flow rate based on the vehicle speed. For example, the liquid supply system can include a controller that receive inputs from the hedging/topping machine such as speed and can adjust the flow rate of treatment to the spray nozzles such that a uniform and deterministic amount of treatment solution is applied per given unit area of land (which may be needed to comply with laws or regulations governing use of the treatments solution, or to provide treatment delivery at a desired or recommend rate for treatment efficacy). In some implementations, the control system can include a visual sensor to detect the presence of a tree or plant in a detection zone (e.g., a zone that corresponds to an area where the treatment solution is about to be applied) and the control system can be configured to activate the treatment solution delivery when the visual sensor indicates a tree or plant is present and deactivate delivery of the treatment solution when the visual sensor indicates a tree or plant is not present in the detection zone (e.g., when the vehicle applying the treatment solution has moved off of a row and is repositioning to move down a another row or side of a row).

In some implementations, a hedger and/or topper machine (or combination machine) can include a sickle type cutting device on a sickle cutting boom and the spray boom can be incorporated into the sickle cutting boom.

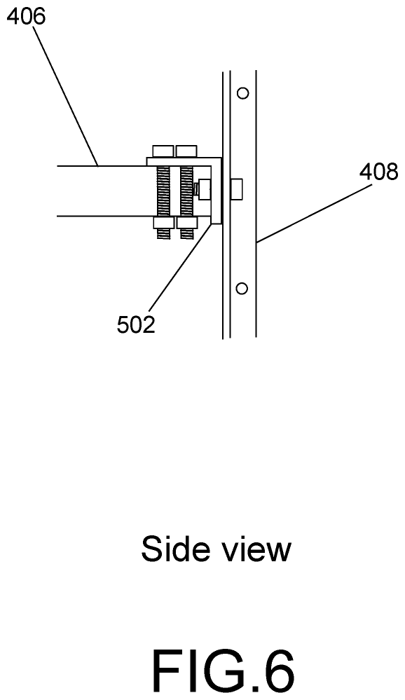

FIG. 5 is a diagram of an example hedger configured with a treatment system having an adjustable spray boom in accordance with some implementations. The spray boom 408 is connected to the attachment boom(s) 406 via adjustable attachment connector(s) 502. The adjustable attachment connectors 502 permit the spray boom 408 position to be adjusted (as shown in grater detailed in FIGS. 6-8) to set a desired distance between the spray boom 408 and the trees (or plants) being treated.

FIGS. 6-8 are diagrams showing details of an adjustable spray boom connection system in accordance with some implementations.

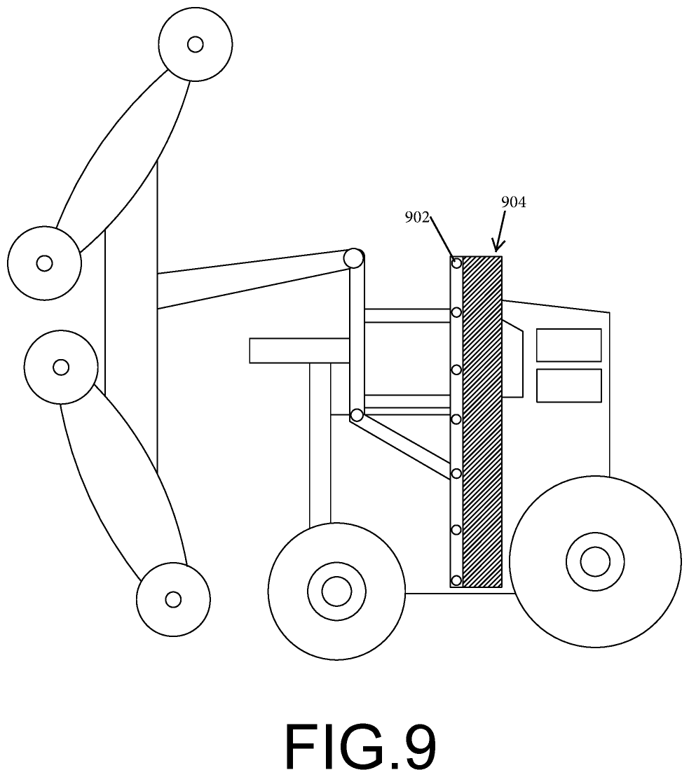

FIG. 9 is a diagram of a hedging or topping machine having a wiper boom to apply treatment solutions in accordance with some implementations. The wiper boom can include nozzles 902 for releasing treatment solution onto the wiper 904 for application onto the cut areas of trees or plants. The treatment solution can also be supplied to the wiper mat internally from within the wiper mat assembly. A treatment solution control system can be used to apply the treatment solution at a deterministic rate (e.g., unit of solution per area of land, etc.) in accordance with the treatment solution label requirements or other specifications such as effective dosage of treatment solution, etc.

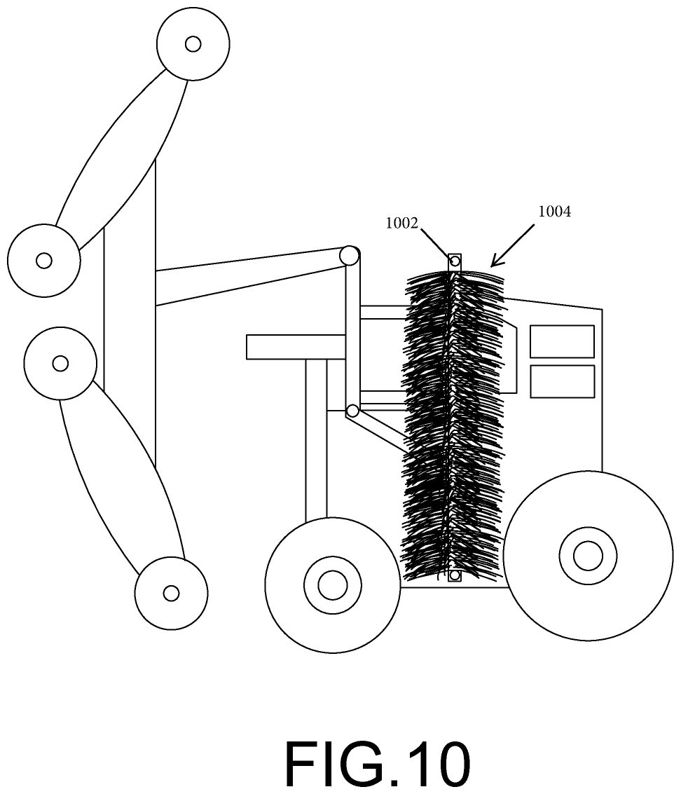

FIG. 10 is a diagram of a hedging or topping machine having a spinning brush boom to apply treatment solutions in accordance with some implementations. The spinning brush boom can include nozzles 1002 for releasing treatment solution onto the spinning brush 1004 for application onto the cut areas of trees or plants. The treatment solution can also be fed internally to the spinning brush from within the spinning brush. A treatment solution control system can be used to apply the treatment solution at a deterministic rate (e.g., unit of solution per area of land, etc.) in accordance with the treatment solution label requirements or other specifications such as effective dosage of treatment solution, etc.

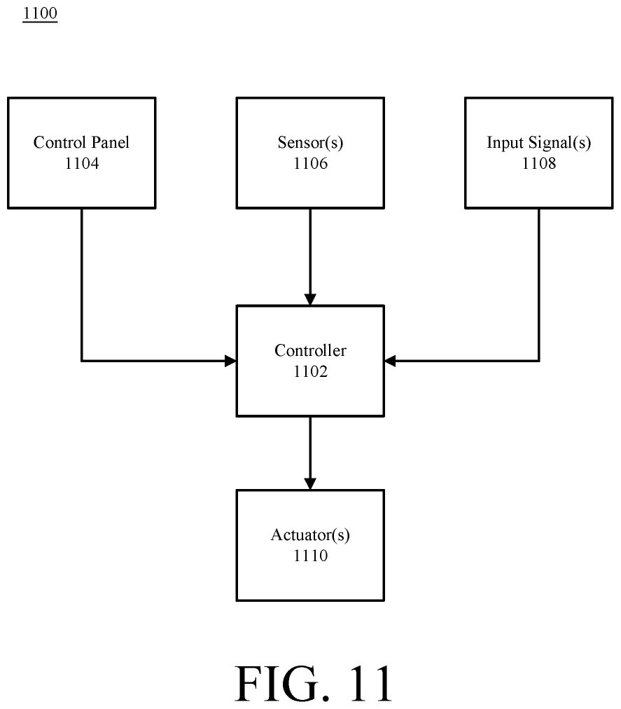

FIG. 11 is a diagram of a treatment control system 1100 in accordance with some implementations. The treatment control system 1100 includes a controller 1102, a control panel 1104, one or more sensors 1106, one or more input signals 1108, and one or more actuators 1110.

The controller 1102 can include a processor, computer-readable memory, and an optional communications system. The one or more sensors 1106 can include one or more of a vehicle speed sensor, a vehicle location sensor, a flow rate sensor, a pressure sensor, a tank level sensor, a visual tree or plant sensor, a distance sensor (e.g., distance from vehicle to plant or trees), a treatment boom angle sensor, a distance traveled sensor, or other sensor. The one or more input signals 1108 can include a vehicle speed signal, a vehicle location signal, a tree/plant presence signal, a pressure signal, a flow rate signal, or other signal. The one or more actuators 1110 can include a pump actuator (e.g., a relay or other suitable actuator), a treatment boom position actuator, or other actuator.

In operation, the controller 1102 can receive inputs from one or more of the control panel 1104, sensors 1106, input signals 1108, process the inputs, and provide an output in the form of control signals to the actuators 1110 (e.g., to cause the treatment to be applied at a deterministic and predetermined rate to trees or plant). The controller 1102 can also store or transmit information about the application of treatment (e.g., distance traveled, area covered, amount of treatment applied, duration of treatment application, rate of treatment application, etc.) for review or documentation.

For example, the controller 1102 can receive an input signal from the control panel to apply a treatment and a signal indicating the rate at which the treatment should be applied (e.g., in units of treatment per unit of land such as 1.5 pounds per acre, etc.). Based on these input signals, and in conjunction with other input signals (e.g., such as vehicle speed, location, visual plant/tree detection, etc.) the controller 1102 can process the input signals and activate one or more actuators 1110 to cause the treatment to be applied to trees or plants at a controlled rate in accordance with the control panel inputs and sensor/signal inputs.

Commercial agriculture operations, such as citrus groves, are subject to numerous state or federal government laws and regulations related to the application of chemicals to the plants or trees. For example, the US EPA states on their website “We review pesticide product labels as part of the licensing/registration process and must approve all label language before a pesticide can be sold or distributed in the United States. The overall intent of the label is to provide clear directions for effective product performance while minimizing risks to human health and the environment. It is a violation of federal law to use a pesticide in a manner inconsistent with its labeling. The courts consider a label to be a legal document. In addition, following labeling instructions carefully and precisely is necessary to ensure safe and effective use.”

Substances manufactured and sold for application to commercial plants or trees (and suitable for application through the disclosed systems and methods), such as antibiotics, herbicides, nutritionals, etc., have labeling that specifies how the product is to be applied including but not limited to a rate of application per unit of land such as pounds per acre (or other similar application rate specification), spray drift limitations, worker protection standards, and/or resistance management.

An example of a pesticide label that would be applicable if the product were used in the disclosed method or system can include Mycoshield EPA Reg. No.:55146-97. The label for this substance requires applicators to wear cumbersome and heat trapping PPE equipment unless they are applying from within an enclosed cab system (e.g., a hedging machine). Under resistance management, the label requires the applicator to use only the specified and full-strength application rates. Spray Drift Precaution is stated as “[t]o help reduce off-target drift, direct spray into the canopy, and turn off outward pointing nozzles at row ends and when spraying outer rows.” For citrus fruits, the label requires a product use rate per acre of 1.5 pounds per acre. Further, there are clearly defined chemical residue limits which growers must adhere to in order to market their product. If residue limits are exceeded, a grower's produce is not marketable and will become worthless.

The specified application rate may be provided by the manufacturer of the substance to maintain optimum health of the plants or trees and/or to comply with a state or federal law or regulation. State and or federal regulations require that commercial growers comply with the labeling of substances to be applied to the plants or trees in the commercial growing operation. Applying substances in a manner that is not in compliance with the labeling is a violation of federal law that can result in civil penalties or potential criminal prosecution.

Accordingly, application of substances to the plants or trees of a commercial growing operation of which the agricultural products are intended for human and/or animal consumption is highly regulated and strict tolerances are maintained when applying substances such as fungicides, bactericides, and insecticides. Most product labels require that the product application must be done in a manner such that the application rate per unit of land is deterministic and can be calculated in a way that permits the grower to set various equipment settings to yield the required application rate. For example, in the presently disclosed systems and methods, the flow rate of treatment liquid can be controlled by the liquid application system such that for given parameters (e.g., speed of operating the hedging machine) the liquid will be applied uniformly and directly to the cut areas of the trees and a known amount of liquid will be applied per acre to be in compliance with the substance labeling and/or other laws or regulations.

Some conventional treatment solutions have an intended use of clearing of unwanted vegetation/trees and maintaining right of ways. The chemicals used in these types of operations are typically herbicides and growth retardants. When these chemicals are used on plants or trees not intended for human and/or animal consumption the chemical labels are far less restrictive and typically only mandate an allowable spray solution concentration of the active ingredient and does not have a strict limitation on amount of active ingredient per unit of land and there are no residue limitations. Thus, these conventional treatment systems may not be applicable for agricultural operations because there is no practical way their systems as described could adhere to the strict chemical application requirements that agricultural operations are subject to.

For example, some conventional systems target individual trees or vegetative limbs. This approach is not suitable for the operations my invention was designed to conduct, e.g., hedging and topping citrus trees. In a typical citrus grove (orchard), trees are grown in hedgerows with a trunk to trunk spacing of 25 feet and a drive middle of 6 feet that is maintained by hedging operations. Tree height is also controlled by topping operations in order to allow for proper light penetration to the lower portions of the tree canopies. A typical tree height for a hedgerow with a 25-foot trunk to trunk spacing is 16 feet. Using the grove spacing and height described above the total cut area per land acre is 88,862.4 square feet.

To put that in perspective, 2.04 acres are cut and sprayed for every acre of land covered. To be economically feasible, the operation needs to cover 30 or more land acres per day producing a cut and sprayed surface area of 2,665,872 square feet (61.2 acres) per day. The disclosed systems and methods are capable of covering this area with ease because a spray boom with evenly spaced nozzles (or a wiper or spinning brush applicator) that uniformly applies treatment to the entire cut area simultaneously and immediately after the cutting operation is utilized, not individual application to limbs or trunks separately. The nozzle arrangements of some conventional systems alone or in conjunction with their proposed cutting apparatuses are not capable of performing the operations that my invention performs.

One conventional system includes a singular rotary blade with a nozzle attached to the blade housing that is mounted on an excavator type machine that is meant to cut limb to limb at multiple orientations. Another conventional system uses multiple rotary blades with a saw arm mounted behind the blades containing nozzle orifices mounted to a boom truck with multiple degrees of freedom and is also designed to cut individual limbs. Both of these conventional systems are not suitably designed for agricultural hedging and topping operations.

For agricultural hedging and topping operations, such as for citrus hedging and topping, the cutting must be conducted at a constant angle and should be uniform throughout the grove. The limitations of the conventional systems become evident upon conceptualizing them trying to cut a straight and uniform hedgerow. For hedging operations using methods in some conventional publications, the operator would have two options. The first option would be to drive the entire length of the row orienting the blade/blades at a vertical position parallel to the desired cut surface, cutting a strip the width of the blade/blades. The operator would then have to turn around and do the same on the opposite side of the row and continue to take out strips until the entire vertical hedgerow surfaces were cut. Considering a blade diameter of 3 feet it would take the operator no less than eleven passes down each row to cut and spray the entire hedgerow.

In contrast, using the disclosed system and method it would take a single pass. The ground on which the machine is driving is uneven and rough and that the blade is mounted far from the machine's roll, pitch, and yaw axes. All the unanticipated movements of the machine due to the rough terrain will be magnified by a length proportional to the distance of the blade from the machine, which will result in an uneven cut and spray application and loss of efficiency. Option two would be for the operator to drive slowly and swipe the blade up and down the vertical face of the tree taking out blade width strips until he reaches the end of the row. Considering a three-foot diameter blade and an operator that was 100% efficient in cutting it would take no less than 3,944.3 up down cycles to complete one acre of hedging. This would be a very slow operation that would rapidly wear out the machine and would most likely cause physical harm to the operator due to the constant shaking from the 16-foot blade oscillations.

Even a conventional system with a blade that is large enough to cover the sixteen-foot height of the tree would not be practical. The cost and weight of a 16 foot diameter saw blade would be prohibitive, not to mention it would be limited to slower rotational speeds due the possibility of the blade literally ripping itself apart from the large centrifugal forces at high rotational speeds. The slow blade rotational speed would result in a more of a tearing cut that would cause excessive damage to the cut vegetation.

It could also be argued that some conventional systems could be lengthened by the addition of more saw blades. This also would add excessive weight to the machine and would increase operating costs significantly. The addition of the many more blades necessary to cover 16 feet would be a maintenance nightmare and would be far less economic than the machines currently used for agricultural hedging and topping.

Now, suppose you decide to attempt to utilize a conventional spraying system in which spray nozzles are mounted to move with the blades of the machines currently in use for citrus hedging and topping. Current citrus hedgers and toppers utilize two blades that are small relative to the cut area allowing them to operate at high rotational speed producing clean cuts. The two blades are mounted on the ends of a rotating arm that has a length that covers the entire height or width of the cut surface. Using the hedger as the example, which consists of two arms that each have two blades. The rotating arms are mounted on the front left and front right of the machine, so it is able to cut the hedgerows on both sides of the machine simultaneously. The arms rotate in a manner where when a blade is at the apex of its rotation it is moving away from the machine and when it is at the bottom of the rotation it is moving towards the machine. The machine operates at a forward speed of approximately 3-5 mph depending on the cutting conditions. As a result of the machine's forward motion the blades are traveling faster relative to the hedgerow during the upper half of their rotation and traveling slower relative to the hedgerow during the bottom half of their rotation. With a nozzle or nozzles moving with the blades of the hedger as taught by some conventional systems there would be an uneven spray distribution across the hedgerow. This occurs because the differences in relative speeds of the nozzles/blades to the hedgerow when traveling in the upper and lower halves of their rotation. Both the upper and lower halves would receive an equal amount of total spray solution because the blades are rotating at a constant speed and spend an equal amount of time in the upper and lower halves of rotation. The problem arises from how the spray is distributed in each half. When compared to the lower half, the upper half receives a better spray distribution because the blades are sweeping across a greater area with each pass. Conversely, the lower half blades are covering less area with each pass, which results in less distribution and areas of higher spray concentration. The higher spray concentration areas could lead to residue issues, cause phytotoxicity, and cause excessive runoff, wasting spray solution. The centrifugal forces from the rotating arm would also give the spray solution a velocity component that is perpendicular to the axis of rotation and parallel to the hedgerow which would result in off target spray deposition resulting in further waste and possible violation of the law. Some conventional techniques would be substantially more affected by centrifugal forces than other because some conventional techniques teach a method of spraying parallel to the saw blades.

In some conventional systems, activation of the spraying or application of liquid substances to the pants or trees is manually turned on or off by the operator of the apparatus and are silent as to flow rate control of the liquid application system. Such conventional systems would not permit the liquid application system to be set in such a way that the application rate of liquid per unit of land would be deterministic and able to be performed in a manner consistent with the laws, regulations, and/or labeling of substances for commercial growing operations.

Thus, these conventional systems, whether viewed alone or in combination, would not be operable in a commercial growing operation and able to be operated in compliance with the commercial growing requirements as outlined above.

It is, therefore, apparent that there is provided, in accordance with the various embodiments disclosed herein, systems and methods for treating or helping prevent microbial infections on plants and trees.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method of treating or preventing microbial infections in plants or trees, the method comprising:
providing a treatment application system configured to apply a treatment to the plants or trees, wherein the treatment application system is integrated with a motorized hedging or topping vehicle including a cutting system, wherein the treatment application system includes, as an applicator, one of a spray applicator, a wiper applicator, or a spinning brush applicator, and wherein the treatment application system includes a controller configured to apply the treatment at a controlled rate of a predetermined amount of treatment per unit of land;
performing at least one of a hedging or topping operation on the plants or trees using the cutting system to produce one or more cut areas on the plants or trees; and
applying the treatment to the one or more cut areas immediately after at least one of the hedging or topping operation using the treatment application system integrated with at least one of the motorized hedging or topping vehicle, wherein the treatment is applied directly and uniformly from the applicator to the one or more cut areas at the controlled rate of application.

2. The method of claim 1, wherein the treatment includes a liquid bactericidal solution of a bactericide and one or more of water or a surfactant.

3. The method of claim 2, wherein the liquid bactericidal solution further includes a nutritional.

4. The method of claim 1, wherein the treatment liquid is applied before sap of the one or more cut areas dries.

5. The method of claim 1, wherein the one or more cut areas expose woody tissue of at least one of the one or more plants or the one or more trees, and wherein the one or more cut areas have moist sap, and wherein the treatment, including a bactericide, is applied before the moist sap of the one or more cut areas dries.

6. A method of at least one of treating or preventing microbial infections on citrus trees, the method comprising:
providing a liquid application system including a treatment liquid, wherein the liquid application system is integrated with a citrus tree motorized vehicular trimming machine having one or more rotary cutting blades operable to perform at least one of a hedging operation or a topping operation on the citrus trees wherein the liquid application system includes spray nozzles positioned perpendicular to the one or more rotary cutting blades, and wherein the liquid application system dispenses the treatment liquid at a controlled rate of flow from the spray nozzles, and wherein the liquid application system is configured to have a selectable application delivery to sides of the citrus trees only, to tops of the citrus trees only, or to both the sides and the tops of the citrus trees; and wherein the liquid application system includes a control panel to control the rate of flow of liquid to the spray nozzles and pressure of the liquid to the spray nozzles;
at least one of hedging or topping one or more citrus trees to produce one or more cut areas on the one or more citrus trees; and
applying the treatment liquid to the one or more cut areas of the one or more citrus trees immediately after at least one of the hedging or the topping operation using the liquid application system integrated with the citrus tree motorized vehicular trimming machine, wherein the treatment liquid is applied directly and uniformly from the nozzles to the one or more cut areas at the controlled rate of flow.

7. The method of claim 6, wherein the treatment liquid is applied before sap of the one or more cut areas dries.

8. The method of claim 6, wherein the one or more cut areas expose woody tissue of the one or more citrus trees, wherein the one or more cut areas have moist sap, and wherein the treatment liquid is applied to the one or more cut areas of the one or more citrus trees before the moist sap of the one or more cut areas dries.

9. A method of at least one of treating or preventing microbial infections on at least one of plants or trees, the method comprising:
providing a liquid application system including treatment liquid, wherein the liquid application system includes one or more nozzles and is integrated with at least one of a motorized hedging vehicle machine having one or more circular cutting blades or a motorized topping vehicle machine having one or more circular cutting blades, and wherein the liquid application system dispenses the treatment liquid at a controlled rate of flow from the one or more nozzles and wherein the liquid application system includes a spray boom connected to a cutting boom, wherein the spray boom is configured to have a first angle that adjusts based on a second angle of the cutting boom, and wherein the spray boom position is adjusted to set a desired distance between the spray boom and one or more trees or one or more plants;
at least one of hedging or topping at least one of the one or more plants or the one or more trees using the one or more circular cutting blades to produce one or more cut areas on at least one of the one or more plants or the one or more trees; and
applying the treatment liquid to the one or more cut areas immediately after at least one of the hedging or topping operation using the liquid application system integrated with at least one of the motorized hedging vehicle machine or the motorized topping vehicle machine, wherein the one or more nozzles are positioned perpendicular to the one or more cut areas, wherein the treatment liquid is applied directly and uniformly from the nozzles to an entire area of the one or more cut areas at the controlled rate of flow.

10. The method of claim 9, wherein the treatment liquid is applied before sap of the one or more cut areas dries.

11. The method of claim 9, wherein the one or more cut areas expose woody tissue of at least one of the one or more plants or the one or more trees, and wherein the one or more cut areas have moist sap, and wherein the treatment liquid, including a bactericide, is applied before the moist sap of the one or more cut areas dries.

12. The method of claim 9, wherein the spray boom is positioned in at least one of a horizontal direction with the one or more nozzles positioned in a vertical direction or a vertical direction with the one or more nozzles positioned in a horizontal direction.

13. The method of claim 9, wherein the treatment liquid includes a liquid bactericidal solution, and one or more of water or a surfactant.

14. The method of claim 1, wherein the second boom is configured to have a second angle that adjusts based on a first angle of the first boom, and wherein the second boom position is adjusted to set a desired distance between the second boom and the one or more of trees or plants.

15. The method of claim 14, wherein the second boom is positioned in at least one of a horizontal direction with the one or more nozzles positioned in a vertical direction or a vertical direction with the one or more nozzles positioned in a horizontal direction.

16. A method of at least one of treating or preventing microbial infections on at least one of plants or trees, the method comprising:
providing a liquid application system including treatment liquid, wherein the liquid application system includes one or more nozzles and is integrated with at least one of a motorized hedging machine or a motorized topping machine, and wherein the liquid application system dispenses the treatment liquid at a controlled rate of flow from the one or more nozzles, and wherein the one or more cutting blades are disposed on a first boom and the one or more nozzles are disposed on second boom different than the first boom;
at least one of hedging or topping at least one of one or more plants or one or more trees to produce one or more cut areas on at least one of the one or more plants or the one or more trees; and
applying the treatment liquid to the one or more cut areas immediately after at least one of the hedging or topping operation using the liquid application system integrated with at least one of the motorized hedging vehicle machine or the motorized topping vehicle, wherein the treatment liquid is applied to an entire area of the one or more cut areas, and wherein the treatment liquid is applied directly and uniformly from the nozzles to the one or more cut areas by the liquid application system at the controlled rate of flow.

17. The method of claim 16, wherein the treatment liquid is applied before sap of the one or more cut areas dries.

18. The method of claim 16, wherein the one or more cut areas expose woody tissue of at least one of the one or more plants or the one or more trees, and wherein the one or more cut areas have moist sap, and wherein the treatment liquid, including a bactericide, is applied before the moist sap of the one or more cut areas dries.

19. The method of claim 16, wherein the liquid application system includes a spray boom connected to a cutting boom, wherein the spray boom is configured to have a first angle that adjusts based on a second angle of the cutting boom, and wherein the spray boom position is adjusted to set a desired distance between the spray boom and the one or more of trees or plants.

20. The method of claim 19, wherein the spray boom is positioned in at least one of a horizontal direction with the one or more nozzles positioned in a vertical direction or a vertical direction with the one or more nozzles positioned in a horizontal direction.

21. The method of claim 16, wherein the treatment liquid includes a liquid bactericidal solution, and one or more of water or a surfactant.
